(19) United States
(12) Patent Application Publication
(10) Pub. No.: US 2026/0081630 A1
(43) Pub. Date: Mar. 19, 2026

(54) MITIGATION OF TRANSMITTED ENERGY ON SUBCARRIERS USING DIVIDED AMPLIFIERS

(71) Applicant: T-MOBILE INNOVATIONS LLC, Overland Park, KS (US)

(72) Inventors: Sharath SOMASHEKAR, Leawood, KS (US); Deveshkumar Narendrapratap RAI, Overland Park, KS (US)

(21) Appl. No.: 18/885,229

(22) Filed: Sep. 13, 2024

(51) Int. Cl. H04B 1/04; H04B 1/00; H04L 5/00

(52) U.S. Cl. CPC H04B 1/0458; H04B 1/006; H04B 1/0071; H04B 1/0078; H04L 5/0098

(57) ABSTRACT

Embodiments of the present disclosure are directed to systems and methods for mitigating energy transmitted on subcarriers in a communications network. For example, a signal intended for transmission can be separated and distributed to different amplifiers at the signal amplification stage. Amplifiers that correspond with regions of blanked PRBs in the signal can be selectively deactivated. In this way, energy wastage is reduced and interference is mitigated due to preventing residual energy transmission that may occur in the blanked regions even when no information is being carried in those regions of the signal.

### SUMMARY

The present disclosure is directed, in part, to mitigating energy transmitted on subcarriers in a communications network by using divided amplifiers, substantially as shown and/or described in connection with at least one of the figures, and as set forth more completely in the claims.

According to various aspects of the technology, communication networks typically provide a range of services, including voice, text, and data transmissions to facilitate communication among users through, for example, base stations and/or user equipment. In modern communications networks, Physical Resource Block (PRB) blanking is used to help mitigate interference and improve network performance. However, despite the implementation of PRB blanking, residual energy transmission within the blanked PRBs continues to pose challenges for operators. This issue arises due to various factors, including spectral leakage, sidelobes from modulation techniques, and the imperfect performance (e.g., nonlinearity) of power amplifiers (PAs). These unwanted energy transmissions within the blanked PRBs can have detrimental effects on the communications network. They lead to increased interference, reducing the quality of service for users and potentially causing errors in data transmission. Furthermore, this interference can extend beyond the intended network, affecting other nearby communication networks operating in adjacent frequency bands. As a result, the efficiency and reliability of the entire communication ecosystem can become compromised.

To address the problem of residual energy transmission in blanked PRBs, a plurality of amplifiers, such as driver amplifiers, can be used. By distributing different portions of the frequency band to different amplifiers, more precise control over the transmission of energy can be obtained. For example, each amplifier may be responsible for amplifying a specific subset of PRBs, enabling selective deactivation of individual amplifiers associated with blanked PRBs. When an input signal (e.g., a baseband signal that has been converted into an analog signal) intended for transmission passes through the amplifiers, the system can deactivate the specific amplifiers corresponding to the blanked PRBs. This selective deactivation helps ensure that no energy is transmitted in these blanked regions, effectively mitigating the problem of residual interference. Accordingly, the present solution involves systems and methods for selectively deactivating one or more of a plurality of amplifiers, mitigating unwanted energy transmission on subcarriers.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates a diagram of an exemplary amplifier and antenna array in which implementations of the present disclosure may be employed;

FIG. 4 illustrates a flow diagram of an exemplary method for mitigating energy transmission in which implementations of the present disclosure may be employed;

FIG. 5 illustrates a flow chart of an exemplary method for mitigating energy transmission in which implementations of the present disclosure may be employed;

FIG. 6 illustrates a flow chart of an exemplary method for mitigating energy transmission in which implementations of the present disclosure may be employed; and

FIG. 7 illustrates a flow chart of an exemplary method for mitigating energy transmission in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition,2022).

The example aspects and embodiments described in the present disclosure are provided within the context of a wireless telecommunication network for illustrative purposes. However, it should be understood that the principles and techniques discussed herein are not limited to wireless networks alone. The concepts and methodologies can be equally applied to other types of communication networks, including but not limited to wired, satellite, and optical networks. These alternative networks are capable of supporting the functionalities and applications described, and their use falls within the scope of the present disclosure.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

As used herein, the term “base station” or “cell” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G,4G, 5G, 6G, 802.11x, and the like.

“User equipment” (UE), “user device,” “mobile device,” and “wireless communication device” are used interchangeably to refer to a device having hardware and software that is employed by a user in order to send and/or receive electronic signals/communication over one or more networks. User devices generally include one or more antennas coupled to a radio for exchanging (e.g., transmitting and receiving) transmissions with an in-range base station that also has an antenna or antenna array. In aspects, user devices may constitute any variety of devices, such as a personal computer, a laptop computer, a tablet, a netbook, a mobile phone, a smartphone, a personal digital assistant, a wearable device, a fitness tracker, or any other device capable of communicating using one or more resources of the network. User devices may include components such as software and hardware, a processor, a memory, a display component, a power supply or power source, a speaker, a touch-input component, a keyboard, and the like. In various examples or scenarios that may be discussed herein, user devices may be capable of using 5G technologies with or without backward compatibility to prior access technologies, although the term is not limited so as to exclude legacy devices that are unable to utilize 5G technologies, for example.

The term “radio unit” (RU) is used herein to refer to one or more software and hardware components that facilitate sending and receiving wireless radio frequency signals, for example, based on instructions from a base station. A RU may be used to initiate and generate information that is then sent out through the antenna array, for example, where the radio and antenna array may be connected by one or more physical paths. A RU may comprise such things as a transceiver module (e.g., including a Digital-to-Analog Converter), an amplifier, an antenna array, and/or a controller. Generally, an antenna array comprises a plurality of individual antenna elements. The antennas discussed herein may be dipole antennas having a length, for example, of ¼, ½, 1, or 1½ wavelengths. The antennas may be monopole, loop, parabolic, traveling-wave, aperture, yagi-uda, conical spiral, helical, conical, radomes, horn, and/or apertures, or any combination thereof. The antennas may be capable of sending and receiving transmission via FD-MIMO, Massive MIMO, 3G, 4G, 5G, and/or 802.11 protocols and techniques.

The term “baseband unit” (BBU) is used herein to refer to one or more software and hardware components that facilitates processing digital signals before transmission (e.g., a baseband signal). A BBU may be used to handle various protocol layers, including Medium Access Control (MAC), Radio Link Control (RLC), and Packet Data Convergence Protocol (PDCP), which help ensure proper data formatting, sequencing, and error handling. A BBU may also manage the flow of data between the network core and the RU, ensuring that user data, control signals, and other necessary information are efficiently processed and transmitted. A BBU may comprise such things as a scheduler, a Digital Signal Processor (DSP), and/or a controller.

“Physical resource block” (PRB) is used to refer to a defined quantity of consecutive subcarriers in a frequency domain that is used for wireless transmission and wireless reception of waveform signals via antennas/antenna elements. In some instances, a physical resource block has a defined quantity of consecutive subcarriers in a frequency domain within one slot in a time domain (e.g., LTE). In other instances, a physical resource block has a defined quantity of consecutive subcarriers in a frequency domain independent of the time domain (e.g., 5G NR). In one example, one resource block has twelve consecutive subcarriers of a frequency domain, where one subcarrier corresponds to one resource element in the resource block. The bandwidth of various physical resource blocks is dependent on the numerology and subcarrier spacing utilized, which corresponds to the frequency bands as defined in kilohertz (kHz) and which determines the cyclic prefix of said block in milliseconds (ms). For example, 5G NR technology supports subcarrier spacing of 15, 30, 60, 120, and 240 kHz while LTE technology supports only one subcarrier spacing of 15 kHz. The physical resource blocks form bandwidth parts (BWP). The physical resource blocks discussed herein are compatible and usable in LTE, LTE-M, 3G, 4G, 5G, IoT, IIoT, NB-IoT, and similar technologies without limitation. For this reason, physical resource blocks are discussed herein in a network-agnostic manner, as the aspects discussed herein can be implemented within each of the different technology environments.

By way of background, PRB blanking is an interference management technique employed in modern communication networks and may be employed at base stations and/or user equipment. In these networks, data transmission may be organized into resource blocks, each of which spans a specific number of subcarriers in the frequency domain and a certain number of symbols in the time domain. Efficient and effective management of these resource blocks is helpful for optimizing network performance and ensuring reliable communication. One of the purposes of PRB blanking is to reduce inter-cell and intra-cell interference, particularly in scenarios with both macro cell and small cells. In such environments, high-power macro cell transmissions can cause significant interference to nearby low-power small cells or user equipment. By strategically blanking certain PRBs, the network can lower interference in both the time and frequency intervals, allowing small cells and other low-power nodes to operate more effectively.

Despite the strategic implementation of PRB blanking to manage interference in communications networks, residual energy transmission within the blanked PRBs remains a persistent issue in real-world scenarios. This problem arises from several technical factors that complicate the ideal functioning of PRB blanking. In practice, the finite response of filters and the inherent sidelobes generated by some modulation techniques lead to spectral leakage, where some energy spills into adjacent frequencies, including those designated as blanked PRBs. Moreover, power amplifiers (PAs), which are important for boosting the signal strength for transmission, often exhibit nonlinear behavior. This nonlinearity results in the generation of harmonics and intermodulation products that further contaminate the blanked PRBs with unwanted energy. Additionally, since amplifiers do not completely turn off, residual energy may still be transmitted on blanked PRBs even when the blanked PRBs carry no information. These imperfections in the amplification and modulation processes cause energy to be transmitted within the blanked PRBs, undermining the intended interference mitigation. For example, the interference levels may degrade the quality of service for users and lead to higher error rates and reduced data throughput. Furthermore, this interference may not be confined to the intended network alone but may also affect nearby communications networks operating in adjacent frequency bands, causing broader spectrum management issues. As a result, the efficiency and reliability of both the local network and the surrounding communication infrastructure may become compromised, highlighting the need for more effective solutions to address this issue.

To address the issue of residual energy transmission in blanked PRBs, the present disclosure is directed to systems and methods for mitigating energy transmitted on subcarriers in a communications network by using divided amplifiers during the amplification process. For example, a plurality of amplifiers, such as driver amplifiers, may be used. An intelligent distribution and selective deactivation of one or more of the plurality of amplifiers helps ensure that no energy is transmitted in the blanked PRBs, thereby mitigating unwanted interference. In a network environment, this solution may be embodied through the integration of a controller that receives an input signal from a radio unit. The input signal, typically an analog signal, may then be processed and distributed to the plurality of amplifiers. The distribution may be managed by the controller, which segments the signal into different frequency bands corresponding to the PRBs. Each amplifier may be responsible for amplifying a specific subset of these PRBs. This segmentation helps ensure that the signal is divided accurately according to the network’s resource allocation plan. After the selective amplification process, the signals amplified by the active amplifiers may be aggregated again by the controller. This recombination process may involve aligning and summing the amplified signals from the active PRBs to form a continuous output signal, which is then passed to an antenna array for transmission. By ensuring that the amplifiers corresponding to the blanked PRBs are deactivated, unwanted energy is prevented from being transmitted in these intervals.

In some aspects, the controller may operate in close communication with the network scheduler, which may employ machine learning (ML) algorithms to predict interference patterns and optimize PRB allocation dynamically. For example, based on the scheduler’s instructions, the controller can intelligently deactivate one or more of the plurality of amplifiers associated with the blanked PRBs. This selective deactivation may be performed before the amplification stage, helping ensure that no residual energy from these PRBs is amplified and transmitted.

Accordingly, a first aspect of the present disclosure is directed to a system for mitigating energy transmitted on subcarriers in a communications network. The system includes a transceiver module, a plurality of amplifiers, and a network device comprising one or more processors. The system further includes a non-transitory computer-readable media configured to receive an input signal from the transceiver module. The media is further configured to distribute a different band of the input signal to each of the plurality of amplifiers and selectively deactivate one or more of the plurality of amplifiers. The media is further configured to amplify the input signal.

A second aspect of the present disclosure is directed to a non-transitory computer-readable media that, when executed, cause a user equipment comprising one or more processors to perform operations for mitigating energy transmitted on subcarriers in a communications network. For example, the computer-readable media is configured to distribute a signal to a plurality of amplifiers and to selectively deactivate one or more of the plurality of amplifiers. The media is further configured to, subsequent to selectively deactivating one or more of the plurality of amplifiers, amplify the signal using the remaining amplifiers of the plurality of amplifiers that were not deactivated. The media is further configured to transmit the amplified signal to an antenna array.

A third aspect of the present disclosure is directed to a method for mitigating energy transmitted on subcarriers in a communications. The method includes receiving an analog signal from a transceiver module, the analog signal comprising a plurality of Physical Resource Blocks (PRBs). The method further includes separating the PRBs into two or more frequency bands where at least one of the two or more frequency bands comprises only blanked PRBs. The method further includes distributing the at least one frequency band comprising only blanked PRBs to an amplifier and selectively deactivating the amplifier.

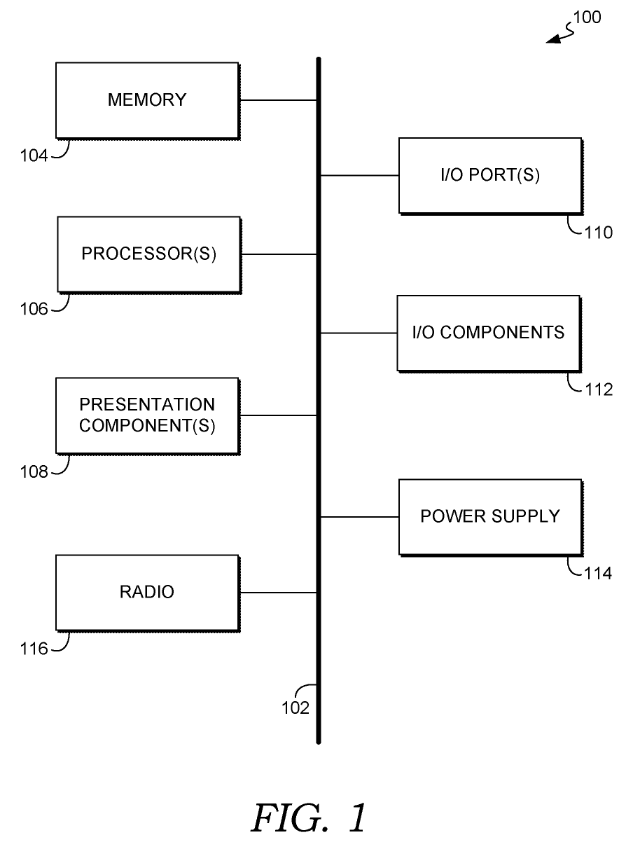

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

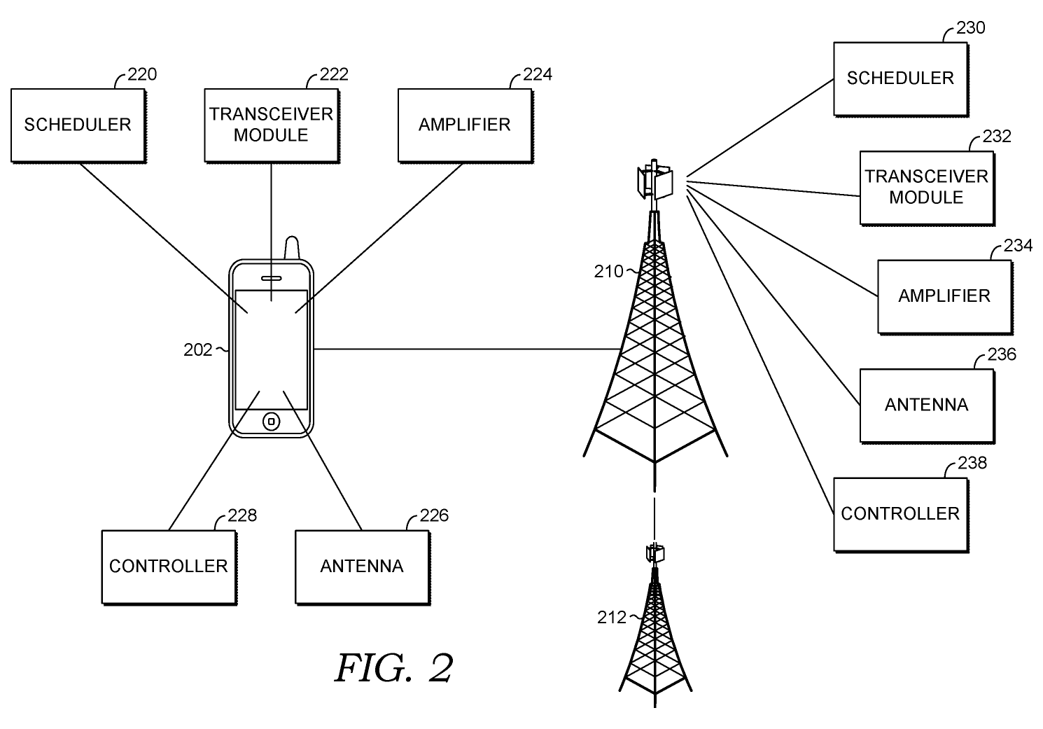

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 represents a high level and simplified view of relevant portions of a modern wireless telecommunication network. At a high level, the network environment 200 may generally be said to comprise one or more UEs, such as UE 202, one or more base stations, such as a first base station 210 and/or a second base station 212, and additional components of radio units at the first UE 202 and the first base station 210, though in some implementations, it may not be necessary for certain features to be present. For example, in some aspects, the network environment 200 may not comprise the second base station 212 (e.g., when the first UE 202 is transmitting toward the first base station 210) and/or may not comprise the first UE 204 (e.g., when the first base station 210 is transmitting toward the second base station 212). The network environment may include a number of routers, switches, and the like. The network environment 200 is generally configured for wirelessly connecting the first UE 202 to data or services that may be accessible on one or more application servers or other functions, nodes, or servers not pictured in FIG. 2 so as to not obscure the focus on the present disclosure.

The network environment 200 comprises the first UE 202, which is illustrated generally, and may take any number of forms, including a tablet, phone, or wearable device, or any other device discussed with respect to FIG. 1 and may have any one or more components or features of the computing device 100 of FIG. 1. In some aspects, the first UE 202 may not be a conventional telecommunications devices (i.e., a device that is capable of placing and receiving voice calls), but may instead take the form of devices that only utilizes wireless network resources in order to transmit or receive data; such devices may include IoT devices (e.g., smart appliances, thermostats, locks, smart speakers, lighting devices, smart receptacles, and the like).

The network environment 200 comprises one or more of the first base station 210 and/or the second base station 212 to which the first UE 202 may potentially connect to (also referred to as ‘camping on,’ ‘attaching,’ in the industry). Though network environment 200 is illustrated with both the first base station 210 and the second base station 212, one skilled in the art will appreciate that more or fewer base stations may be present in any particular network environment. Furthermore, the first base station and the second base station 212 may have any one or more components or features of the computing device 100 of FIG. 1. Each of the first base station 210 and the second base station 212 of the network environment 200 is configured to wirelessly communicate with UEs, such as the first UE 202 and/or other base stations (e.g., such as each other). In aspects, any of first base station 210 and the second base station 212 may communicate with one or more of the first UE 202 or each other using any wireless telecommunication protocol desired by a network operator, including but not limited to 3G, 4G, 5G, 6G, 802.11x and the like. However, in some aspects, signals from the first UE 202, the first base station 210, and/or the second base station 212 may be transmitted towards one another without being in direct communication with one another. For example, energy transmitted on blanked PRBs in the signals can cause interference between base stations and user equipment within a communications network as well as external networks by the energy transmissions in certain bands of the transmitted signals.

The network environment 200 comprises components of the radio units on the first UE 202 and the first base station 210. The illustrated components for a radio unit of the first UE 202 may include a transceiver module 222, an amplifier 224, an antenna array 226, and/or a controller 228, which may communicate with, and be coordinated by, a scheduler 220. Similarly, the illustrated components for the radio unit on the first base station 210 may include a transceiver module 232, an amplifier 234, an antenna array 236, and/or a controller 230, which may communicate with, and be coordinated by, a scheduler 230. Additional components of the radio units may be present but are not illustrated and/or discussed for the sake of clarity. For example, it may be understood that the second base station 212 has similar components, although not illustrated.

The schedulers 220,230 help by efficiently allocating resources to ensure optimal performance and adherence to system constraints. Specifically, when dealing with blanked PRBs, the schedulers 220,230 must strategically manage the distribution of available PRBs to various users and services. Blanked PRBs are intentionally left unused to avoid interference and/or to meet certain regulatory requirements. By dynamically adapting to real-time conditions and considering the presence of blanked PRBs, the schedulers 220,230 help to optimize the use of available resources, maintain signal quality, and enhance the overall efficiency of the system. The schedulers 220,230 interact with the other components in the radio units. For example, in the context of the first UE 202, the scheduler 220 may interact with the transceiver module 222, the amplifier 224, and the antenna array 226 by determining the optimal allocation of resources and transmission parameters, then instructing these components to implement the planned signal transmissions. The scheduler 220 may help ensure that the transceiver module 222 processes and modulates the signal appropriately, that the amplifier 224 provides the necessary power levels, and that the antenna array 226 directs the signal accurately towards its intended recipient. Scheduler 230 may provide similar functionality for the first base station 210.

The transceiver modules 222,232 may serve as the central component responsible for converting digital data into radio frequency signals and vice versa. For example, in the context of preparing a signal for transmission that includes blanked PRBs, the transceiver modules 222,232 may receive scheduling instructions that specify which PRBs are blanked and which are available for transmission. The transceiver modules 222,232 process the information to modulate the signal appropriately, ensuring that no data is transmitted over the blanked PRBs to help avoid interference and meet regulatory constraints; however, as discussed previously, there still remains the problem of residual energy transmission even though no data is being transmitted. The transceiver modules 222,232 may work with a Digital Signal Processor (DSP) to encode and modulate the signal, and with the schedulers 220,230 to ensure compliance with the resource allocation plan. Once the signal is prepared, the transceiver modules 222,232 send the signal to the amplifiers 224,234.

The amplifiers 224,234 may refer to a device that increases the power of a signal to ensure it can be transmitted over longer distances without degradation. The amplifiers 224,234, as discussed herein, may encompass both driver amplifiers and power amplifiers. Driver amplifiers are typically used to provide the necessary gain to drive the input of a subsequent stage, such as a power amplifier. Driver amplifiers operate at lower power levels and serve to prepare the signal for final amplification. Power amplifiers, on the other hand, operate at higher power levels and are responsible for providing the final boost to the signal. When referring to the amplifiers 224,234, it could mean one or more amplifiers (e.g., a plurality of amplifiers) and include any combination of driver amplifiers, power amplifiers, or multiple units of either type.

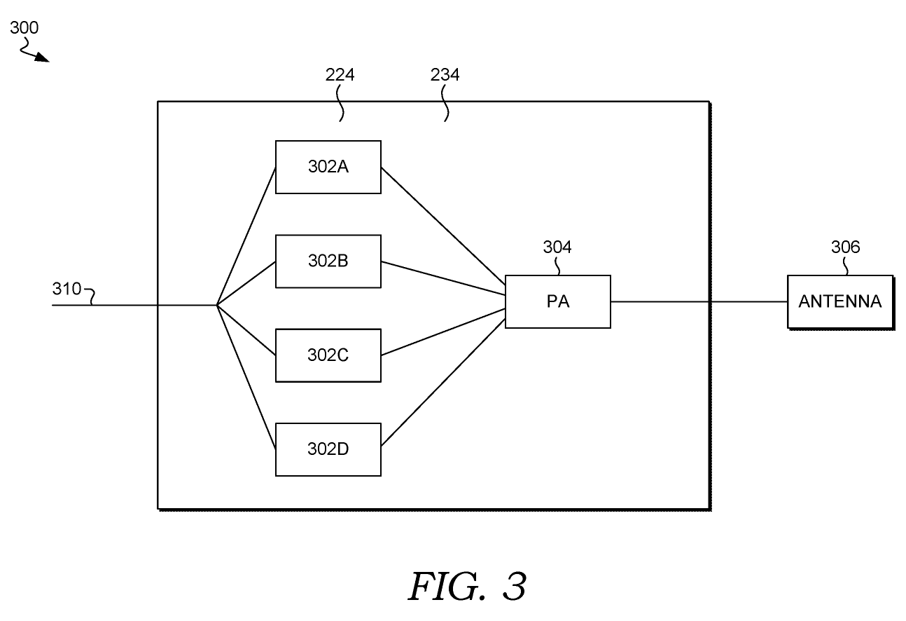

As will be discussed further in regards to FIG. 3, the amplifiers 224,234 may be embodied as a plurality of amplifiers. The signal (e.g., an input signal or an analog signal) can be separated into different frequency bands, each managed by distinct amplifiers, allowing for more efficient amplification tailored to specific parts of the spectrum. For example, when certain PRBs within these bands are blanked, the amplifiers handling those specific bands can be selectively deactivated. This selective deactivation of amplifiers reduces power usage and helps prevent the transmission of unwanted signals in the blanked PRBs, thereby enhancing overall performance and reducing interference. After passing through the amplifiers 224,234, the signal only includes the active PRBs, with the blanked PRBs effectively omitted due to the selective deactivation of certain amplifiers. This amplified signal is then sent to the antenna arrays 226,236.

The antenna arrays 226,236 help with shaping and directing the signal for transmission. The antenna arrays 226,236 take the input signal, which is now an aggregate of all the active frequency bands, and applies beamforming techniques to focus the transmission towards the intended target. The ultimate signal transmitted by the antenna arrays 226,236 is a radio frequency signal that is free of the blanked PRBs. This signal helps ensure reliable communication with minimal interference.

The controllers 228,238 may be a newly added component or may be integrated into an existing component, such as the transceiver modules 222,232 or the amplifiers 224,234. The controllers 228,238 described herein may be implemented as hardware, software, or a combination of both. The specific implementation may vary depending on system requirements and design considerations. The controllers 228,238 may be responsible for coordinating and executing the selective deactivation of amplifiers in a communications network. For example, the controllers 228,238 may interface seamlessly with the schedulers 220,230 to manage and optimize the use of PRBs.

The controllers 228,238 may be able to selectively deactivate amplifiers associated with blanked PRBs. For example, upon receiving scheduling instructions, the controllers 228,238 may assess which PRBs are blanked and determine which amplifier of the plurality of amplifiers will handle these specific PRBs. Before the signal is amplified, the controllers 228,238 deactivates the amplifier associated with the blanked PRBs, helping to ensure that no residual energy from the blanked PRBs is amplified and transmitted. In some aspects, the controllers 228,238 may employ machine learning algorithms to predict interference patterns and dynamically optimize PRB allocation. For example, by analyzing historical data and real-time conditions, the controllers 228,238 may make informed decisions to enhance perform of the communications network. The controllers 228,238 communication with the schedulers 220,230 may allow it to receive timely updates on PRB allocations and adapt the amplifier activation states accordingly. This coordination helps ensure that only the necessary PRBs are amplified.

Turning now to FIG. 3, an exemplary network environment 300 is illustrated in accordance with aspects herein. The network environment 300 may comprise a plurality of amplifiers, such as amplifiers 302A-D, which may be driver amplifiers. The network environment may also comprise a power amplifier 304, which may be the same as the power amplifiers 224,234, and an antenna array 306, which may be the same as the antenna arrays 226,236, that help with the transmission of a signal 310. By separating an amplifier (e.g., amplifier 224 and/or amplifier 234) into separate and distinct amplifiers (e.g., the plurality of amplifiers 302A-D), each amplifier may be responsible for amplifying specific frequency bands of the signal 310. For example, when the signal 310 is received, it may be separated into constituent frequency bands before being distributed to the distinct amplifiers 302A-D for individual processing. Notably, the signal 310 does not need to be split evenly between the amplifiers 302A-D; each of the amplifiers 302A-D can be allocated bands based on system requirements.

In some aspects, one of the plurality of amplifiers 302A-D, such as amplifier 302D, may have a band distributed to it that comprises only blanked PRBs. To avoid unnecessary power consumption and potential interference, amplifier 302D may be selectively deactivated before it can amplify the blanked PRBs. This selective deactivation ensures that only the active portions of the signal are amplified. In some aspects, the remaining amplifiers that were not selectively deactivated, such as amplifiers 302A-C, may be allocated bands with active PRBs and may amplify their respective bands. The amplified signal 310 from these amplifiers may be aggregated back into a single composite signal. This aggregated composite signal 310, now consisting only of the desired amplified bands, may be passed to the power amplifier 304 for the final boost in power. This composite signal 310, free of the blanked PRBs, is then directed to the antenna array 306 as an output signal. The antenna array 306 applies beamforming techniques to transmit the composite output signal 310. The output signal 310 may comprise only the amplified bands of the original signal 310.

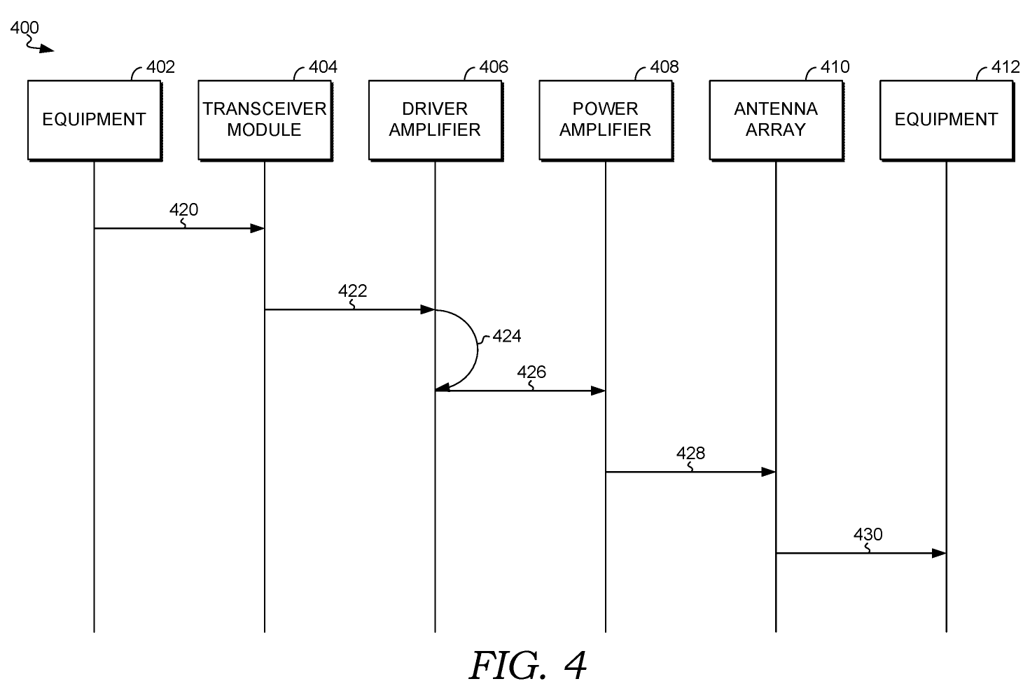

FIG. 4 illustrates an example flow diagram for mitigating energy transmitted on subcarriers in a communications network in accordance with aspects herein. The components discussed may be the same or similar to previous components discussed with regards to FIGS. 1-3. At a first step 420, an equipment 402, which may be a UE or a base station, prepares a signal for transmission. For example, the equipment 402 may determine the data to be transmitted, including the allocation of PRBs, specifying which PRBs are active and which are blanked. This transmission information is then sent to a transceiver module 404 on the equipment 402. At a second step 422, the transceiver module 404 may process the signal by encoding and modulating it according to the transmission requirements. The transceiver module 404 ensures that the signal conforms to the PRB allocation, incorporating blanked PRBs as null data areas. Once processed, the signal is sent to a driver amplifier 406.

At a third step 424, when the driver amplifier 406 consists of a plurality of amplifiers, such as amplifiers 302A-D, a controller, such as controllers 228,238, may coordinate splitting the signal into corresponding frequency bands and distributing these bands to the distinct amplifiers. In some aspects, one of the plurality of amplifiers may be allocated with only blanked PRBs. In such aspects, the amplifier allocated with only blanked PRBs may be selectively deactivated to avoid unnecessary amplification. The remaining amplifiers that were not selectively deactivated may amplify their respective bands.

At a fourth step 426, the amplified signal may be aggregated into a single composite signal and sent to a power amplifier 408 for a final boost in power. At a fifth step 428, the signal is passed to an antenna array 410 on the equipment 402, which uses beamforming to direct and shape the signal for transmission to an intended target such as an equipment 412. At a sixth step 430, the signal is transmitted by the antenna array 410 to the user equipment 412; however, in some aspects, the intended target may not be the equipment 412 but the signal may still be transmitted toward the equipment 412 (e.g., an out-of-network equipment) such that the equipment 412 still benefits from the mitigating of energy transmission on blanked PRBs.

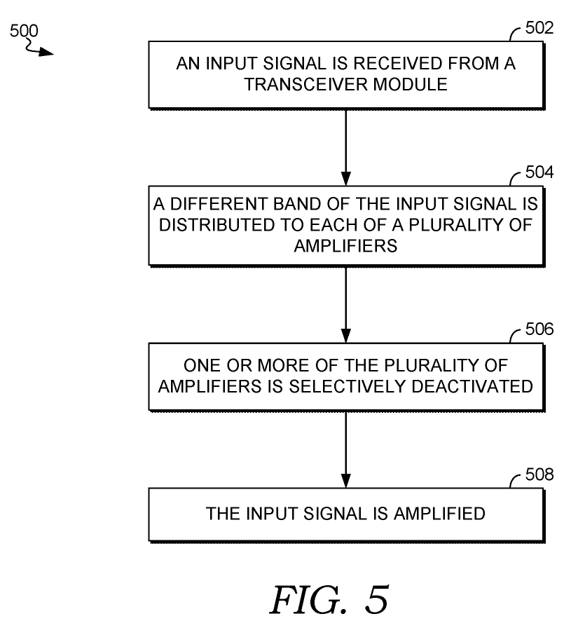

Turning now to FIG. 5, a flow chart is provided that illustrates one or more aspects of the present disclosure relating to a method 500 for mitigating energy transmitted on subcarriers in a communications network. At a first step 502, an input signal is received from a transceiver module. In some aspects, the input signal is received from the transceiver module of a base station. In other aspects, the input signal is received from the transceiver module of a user equipment. At a second step 504, a different band of the input signal is distributed to each of a plurality of amplifiers. In some aspects, distributing the input signal comprises splitting the input signal into separate bands. In some aspects, the input signal distributed to at least one of the plurality of amplifiers comprises a blanked PRB. At a third step 506, one or more of the plurality of amplifiers is selectively deactivated. At a fourth step 508, the input signal is amplified.

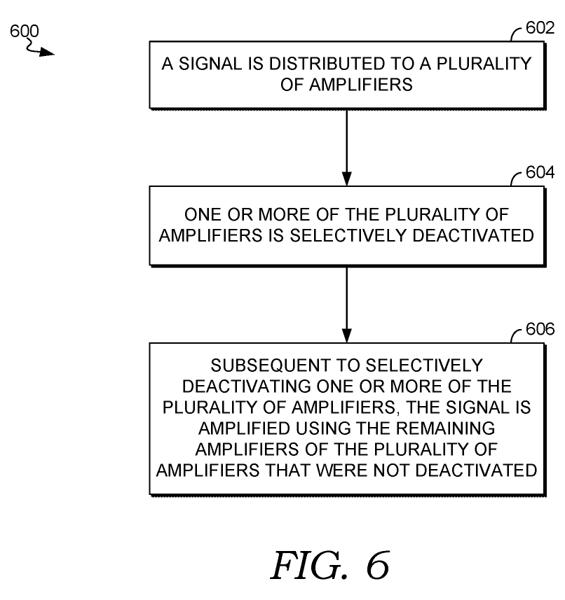

Turning now to FIG. 6, a flow chart is provided that illustrates one or more aspects of the present disclosure relating to a method 600 for mitigating energy transmitted on subcarriers in a communications network. For example, at a first step 602, a signal is distributed to a plurality of amplifiers. At a second step 604, one or more of the plurality of amplifiers is selectively deactivated. At a third step 606, subsequent to selectively deactivating one or more of the plurality of amplifiers, the signal is amplified using the remaining amplifiers of the plurality of amplifiers that were not deactivated.

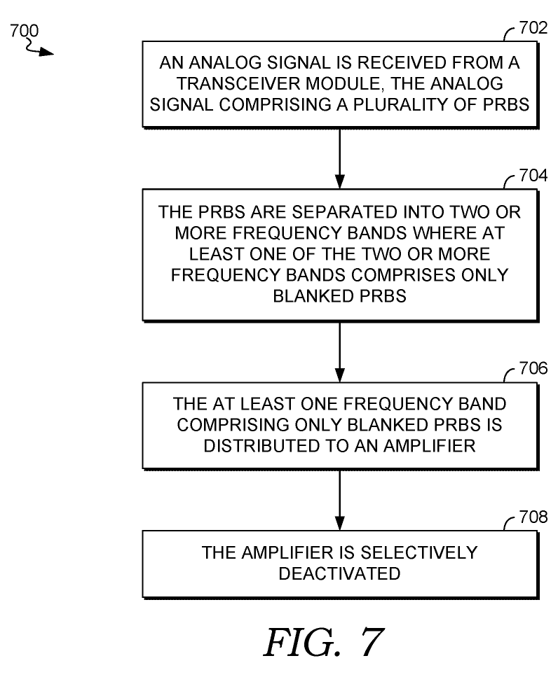

Turning now to FIG. 7, a flow chart is provided that illustrates one or more aspects of the present disclosure relating to a method 700 for mitigating energy transmitted on subcarriers in a communications network. For example, at a first step 702, an analog signal is received from a transceiver module, the analog signal comprising a plurality of PRBs. At a second step 704, the PRBs are separated into two or more frequency bands where at least one of the two or more frequency bands comprises only blanked PRBs. At a third step 706, the at least one frequency band comprising only blanked PRBs is distributed to an amplifier. At a fourth step 708, the amplifier is selectively deactivated.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for mitigating energy transmitted on subcarriers in a communications network, the system comprising:
a transceiver module;
a plurality of amplifiers;
a network device comprising one or more processors; and
a non-transitory computer-readable media comprising executable instructions that, when executed, causes the network device to perform operations in the communications network, the executable instructions comprising the steps of:
receiving an input signal from the transceiver module;
distributing a different band of the input signal to each of the plurality of amplifiers;
selectively deactivating one or more of the plurality of amplifiers; and
amplifying the input signal.

2. The system of claim 1, wherein the amplifiers are driver amplifiers.

3. The system of claim 2 further comprising transmitting the amplified signal to one or more power amplifiers.

4. The system of claim 1, wherein the input signal is a baseband signal that has been converted to an signal.

5. The system of claim 1, wherein distributing the input signal comprises splitting the input signal into separate bands.

6. The system of claim 1, wherein the input signal distributed to at least one of the plurality of amplifiers comprises a blanked Physical Resource Block (PRB).

7. The system of claim 6, wherein the at least one amplifier comprising a blanked PRB is selectively deactivated.

8. The system of claim 1, wherein at least one band distributed to an amplifier of the plurality of amplifiers comprises only blanked PRBs.

9. The system of claim 1, wherein the input signal is received from the transceiver module of a base station.

10. The system of claim 1, wherein the input signal is received from the transceiver module of a user equipment.

11. The system of claim 1, wherein amplifying the signal comprises providing an initial gain to the input signal.

12. The system of claim 1 further comprising aggregating the amplified input signal.

13. The system of claim 12, wherein the amplified input signal is aggregated into a composite signal.

14. The system of claim 1 further comprising transmitting the amplified input signal to an antenna array as an output signal.

15. The system of claim 14, wherein the output signal comprises only the amplified bands of the input signal.

16. A non-transitory computer-readable media comprising executable instructions that, when executed, causes a network device comprising one or more processors to perform operations for mitigating energy transmitted on subcarriers in a communications network, the executable instructions comprising the steps of:
distributing a signal to a plurality of amplifiers;
selectively deactivating one or more of the plurality of amplifiers; and
subsequent to selectively deactivating one or more of the plurality of amplifiers, amplifying the signal using the remaining amplifiers of the plurality of amplifiers that were not deactivated.

17. The computer-readable media of claim 16, wherein the signal distributed to at least one of the plurality of amplifiers comprises a blanked Physical Resource Block (PRB).

18. The computer-readable media of claim 17, wherein the at least one amplifier comprising a blanked PRB is selectively deactivated.

19. A method for mitigating energy transmitted on subcarriers in a communications network, the method comprising:
receiving an analog signal from a transceiver module, the analog signal comprising a plurality of Physical Resource Blocks (PRBs);
separating the PRBs into two or more frequency bands, at least one of the two or more frequency bands comprising only blanked PRBs;
distributing the at least one frequency band comprising only blanked PRBs to an amplifier; and
selectively deactivating the amplifier.

20. The method of claim 19 further comprising amplifying the analog signal subsequent to deactivating the amplifier.
